(19) United States
(12) Patent Application Publication
(10) Pub. No.: US 2017/0223497 A1
(43) Pub. Date: Aug. 3, 2017

(54) MOBILE LOCATION BASED INFORMATION PLATFORM

(71) Applicant: CHENG-YU WANG, TAIPEI CITY (TW)

(72) Inventor: CHENG-YU WANG, TAIPEI CITY (TW)

(21) Appl. No.: 15/012,474

(22) Filed: Feb. 1, 2016

(51) Int. Cl. H04W 4/02; H04W 4/04

(52) U.S. Cl. CPC H04W 4/021; H04W 4/04; H04W 4/025; H04W 4/028

(57) ABSTRACT

A platform and method for efficiently providing appropriate travel and tour information based on the user's location. A geofence is established and associated with a site. When a user with a user device crosses the geofence a mobile application on the user device is triggered and information associated with the site is retrieved from a mobile database and provided to the user via the user device. The user's line of sight is used to determine if the user can see the site from their current location. If they can see the site they are provided with the information for the site. If they cannot see the site the information is not provided. The user's direction of movement is used to determine potential destination sites.

### BACKGROUND OF THE INVENTION

Field of the Invention

The present invention relates to portable information systems. More specifically, the present invention discloses a platform and method for efficiently providing appropriate travel and tour information based on the user's location.

Description of the Prior Art

Conventional travel information is provided to users in print format such as guide books or magazines. While the printed guide may contain information it is typically too general and can not be personalized for individual travelers to be very useful. Additionally, the guides are bulky and inconvenient and contain pages of information that aren't needed by the traveler.

Another typical method of providing travel information is via a travel website. However, in order to obtain up to date information the traveler must have an active internet connection. This is usually difficult for users traveling in a foreign country or city away from home. Additionally, to access the desired information the user must search and locate the information they want. This is time consuming and negatively affects the user experience.

Therefore, there is need for an efficient system and method for providing travel information to users according to the user's current location.

### SUMMARY OF THE INVENTION

To achieve these and other advantages and in order to overcome the disadvantages of the conventional method in accordance with the purpose of the invention as embodied and broadly described herein, the present invention provides a platform and method for efficiently providing accurate, up-to-date, and appropriate travel and tour information to users according to the user's current physical location.

The present invention comprises a download-able application for a user device, for example a mobile phone. After installation is complete, the information database of the application is updated when appropriate. For example, information is pushed to the user device when the database is updated or pulled from the database when the user wants to expand the application database on their device.

Information in the application database is also updated based on, for example, user request, e-ticket information, itinerary, travel agent, tour code, flight code, flight number, country code, city code, etc.

When the user travels to a destination, the application provides appropriate travel information to the user via the user device. As the user walks, drives, or rides, the user will enter a proximity to a location, landmark, or site. When encountering a determined perimeter in proximity, the application triggers an appropriate message or information regarding the assigned location, landmark, or site without the user needing to request the information.

Therefore, the user efficiently receives accurate travel information, in a hands free manner on their electronic device, when the user approaches a proximity of the location. Furthermore, the user is not overwhelmed with information that they don't currently need or want because they are not close to the location.

The present invention utilizes GPS, GPRS, 3G, 4G, Triangulation, or a combination of these to determine the location of the user device.

Additionally, the present invention provides appropriate travel information to the user via the user device when the location, landmark, or site is within line of sight to the user.

Furthermore, the present invention can determine the direction of travel of the user by calculating the direction between points based on latitude and longitude. This further increases the accuracy and appropriateness of the travel information to provide to the user. A minimum of two points is utilized and using more points increases the accuracy. Additionally, a gyroscope can be utilized to determine the direction of a user.

As a result, the present invention allows a user to move naturally and be provided with appropriate information based on where the user is located or in which direction the user is moving.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings:

FIG. 1 is a drawing illustrating a platform for providing appropriate information based on a user's location according to an embodiment of the present invention;

FIG. 2A is a drawing illustrating a platform for providing appropriate information based on a user's location;

FIG. 2B is a drawing illustrating a platform for providing appropriate information based on a user's location;

FIG. 2C is a drawing illustrating a platform for providing appropriate information based on a user's location and direction of movement;

FIG. 2D is a drawing illustrating a platform for providing appropriate information based on a user's location and direction of movement;

FIG. 2E is a drawing illustrating a platform for providing appropriate information based on a user's location using various geofence shapes;

FIG. 2F is a drawing illustrating a platform for providing appropriate information based on a user's location using overlapping geofences;

FIG. 2G is a drawing illustrating a platform for providing appropriate information based on a user's location using nested geofences;

FIG. 2H is a drawing illustrating a platform for providing appropriate information based on a user's location and line of sight;

FIG. 2I is a drawing illustrating a platform for providing appropriate information based on a user's location and line of sight;

FIG. 2J is a drawing illustrating a platform for providing appropriate information based on a user's location and line of sight;

FIG. 2K is a drawing illustrating a platform for providing appropriate information based on a user's location using geofences;

FIG. 3A is a flowchart illustrating a method for providing appropriate information based on a user's location;

FIG. 3B is a flowchart illustrating a method for providing appropriate information based on a user's location using geofences;

FIG. 3C is a flowchart illustrating a method for providing appropriate information based on a user's location using geofences;

FIG. 3D is a flowchart illustrating a method for providing appropriate information based on a user's location using geofences;

FIG. 3E is a flowchart illustrating a method for providing appropriate information based on a user's location using line of sight;

FIG. 3F is a flowchart illustrating a method for providing appropriate information based on a user's location using direction of user movement; and

FIG. 3G is a flowchart illustrating a method for providing appropriate information based on a user's location using geofences, line of sight, and direction of user movement.

### DESCRIPTION OF THE PREFERRED EMBODIMENTS

Reference will now be made in detail to the preferred embodiments of the present invention, examples of which are illustrated in the accompanying drawings. Wherever possible, the same reference numbers are used in the drawings and the description to refer to the same or like parts.

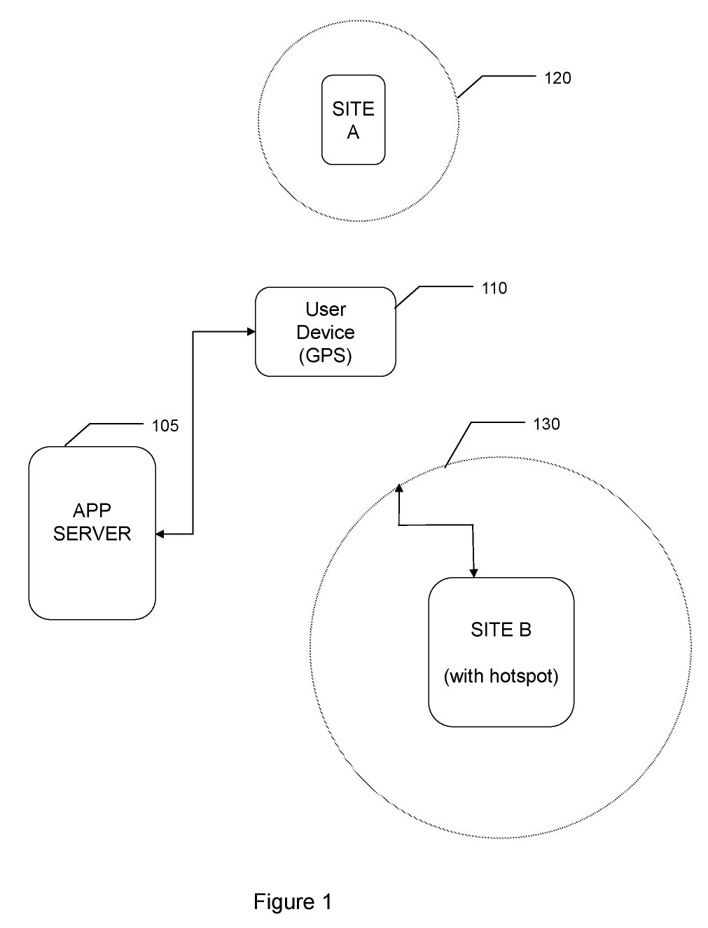

Refer to FIG. 1. The platform and method for providing appropriate information based on a user's location according to an embodiment of the present invention comprises an application server 105, a user device 110, and at least one geofence 120, 130 related to at least one location Site A, Site B.

The application server 105 comprises, for example, a computer, a tablet, a portable computer, a mobile telephone, or other electronic device with an internet connection and a memory for storing a travel information application and server database.

The application comprises, for example, a download-able application to a mobile electronic user device 110. The server database comprises a database of travel and tour information and data.

The user device 110 comprises, for example, a mobile phone or a tablet with a memory for storing the travel information application and mobile database.

The user device 110 connects to the application server 105 and downloads the application. The user then installs the application on the user device 110. After installation the user device 110 connects to the application server 105 and downloads appropriate travel data from the server database. The travel data is added to the mobile database on the user device 110 and locally accessible by the information application even when off-line.

A Site A geofence 120 is created and associated with Site A. A Site B geofence 130 is created and associated with Site B.

When the user with the user device 110 contacts or crosses the Site A geofence 120, the mobile application is triggered to access the mobile database and retrieve data and to provide information appropriate to Site A to the user via the user device 110. When the user with the user device 110 contacts or crosses the Site B geofence 130, the application is triggered to access the mobile database and retrieve data and to provide information appropriate to Site B to the user via the user device 110.

The information comprises, for example, site name, site established date, site history, site usages, unique points or issues, size, height, capacity, costs, unique facts, odd facts, prices, discounts, limited time offers, coupons, marketing information, product information, or other items that are interesting or valuable to users. In an embodiment when the user crosses the geofence and the application is triggered, the application will initially only provide the site name. If the user would like more information and details, the user will indicate to the application to provide more information. For example, as the user crosses the geofence the site's name is audible spoken over the headphones of the user device. If the user would like more information, the user can speak a voice command or press a button to continue and the application will begin providing more information to the user either via the headphones or the display screen of the user device.

In an embodiment of the present invention a wireless hotspot is provided at the location and when the user with the user device contacts or crosses the geofence, the user device connects with the hotspot and new or updated information is accessed via the hotspot by the mobile information application and provided to the user via the user device 110. In this way, the mobile database in the user device is routinely updated with the lasted information about the site.

For example, if the site is a concert hall, as the user crosses the geofence the mobile application connects to the hotspot and retrieves the latest schedule of events for the concert hall without needing to search or find help to ask for the information.

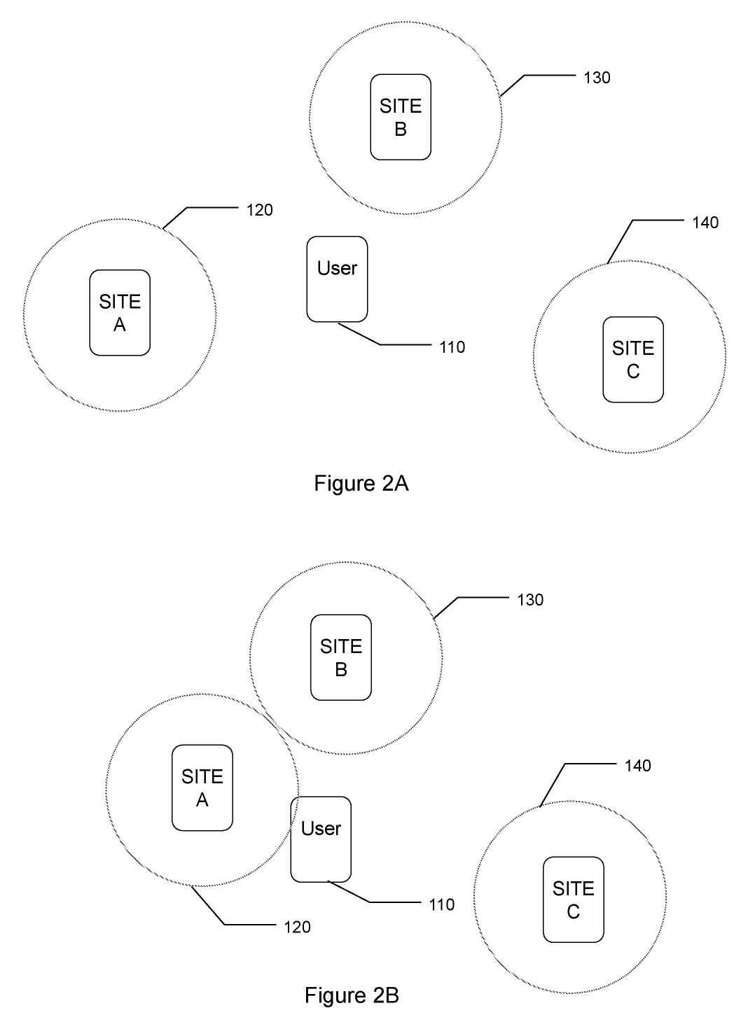

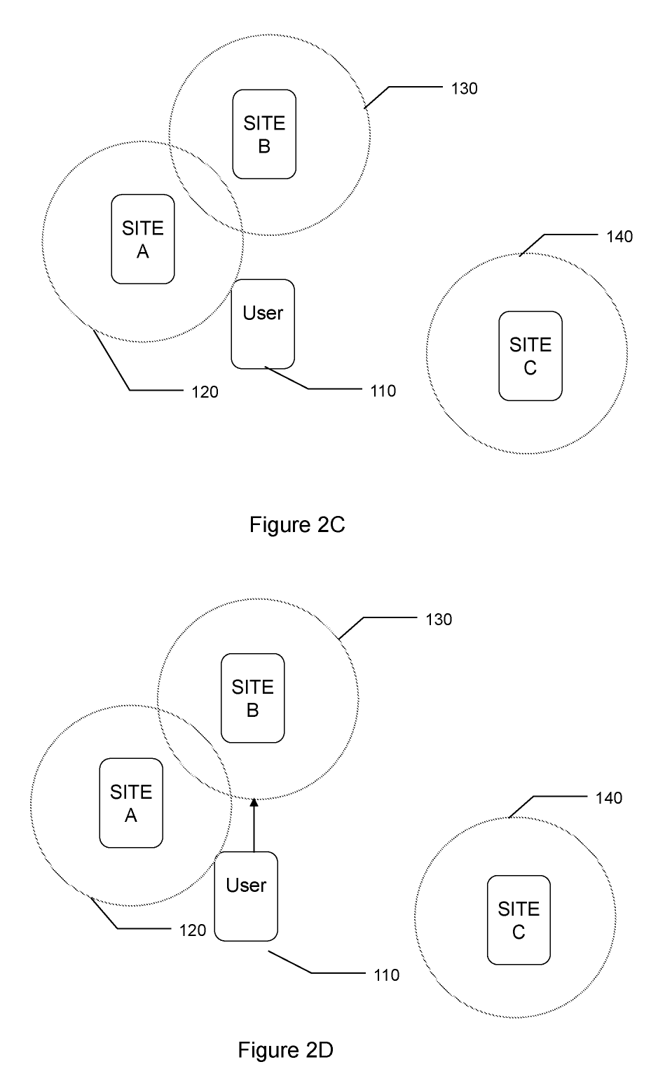

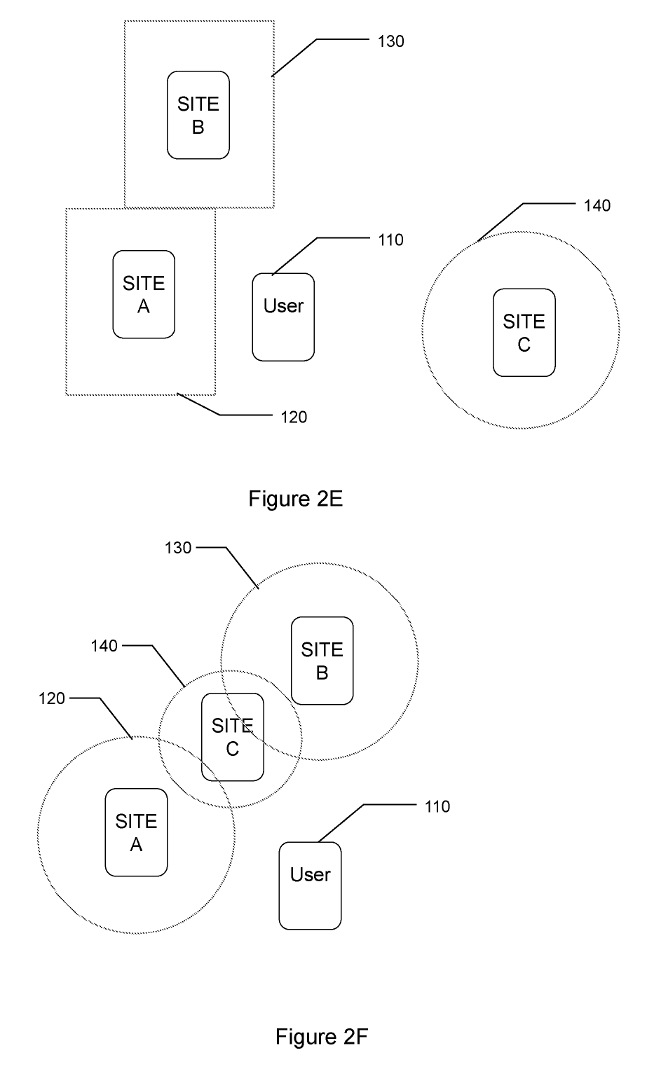

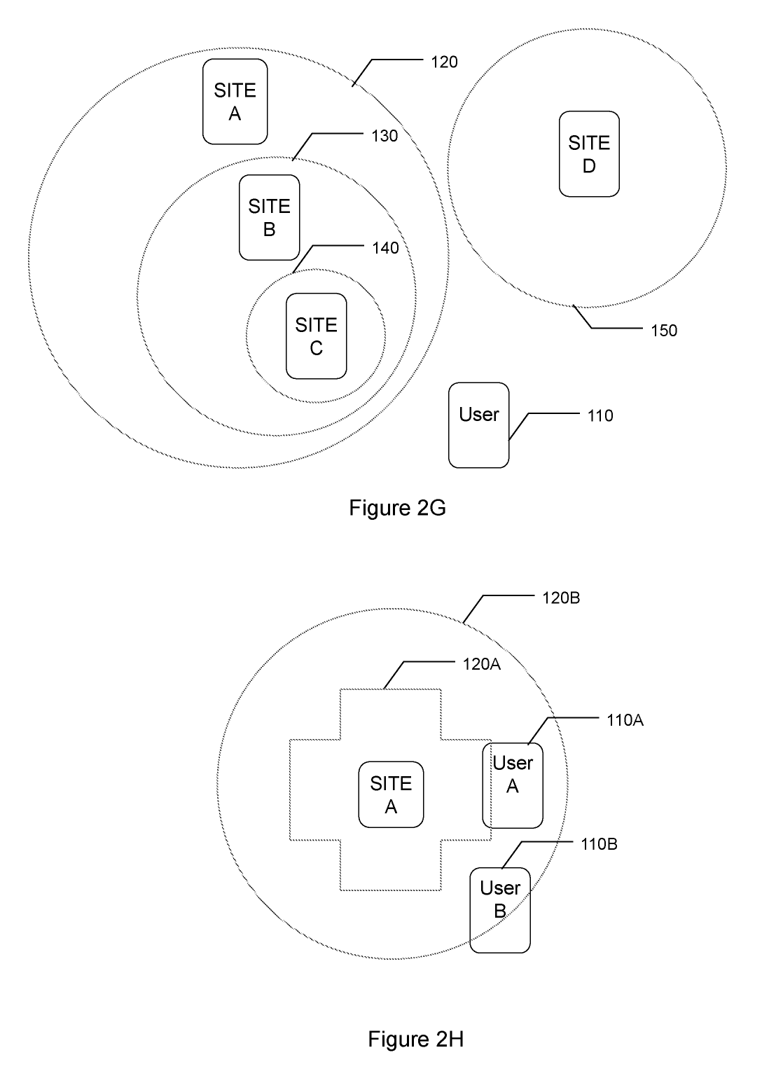

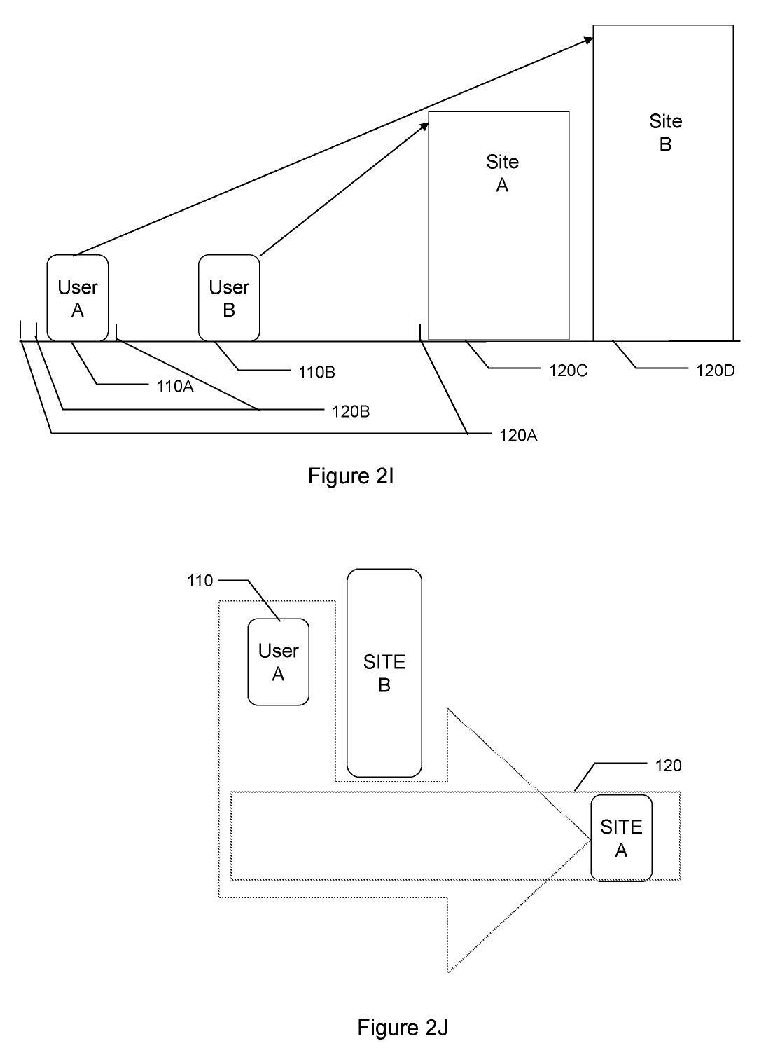

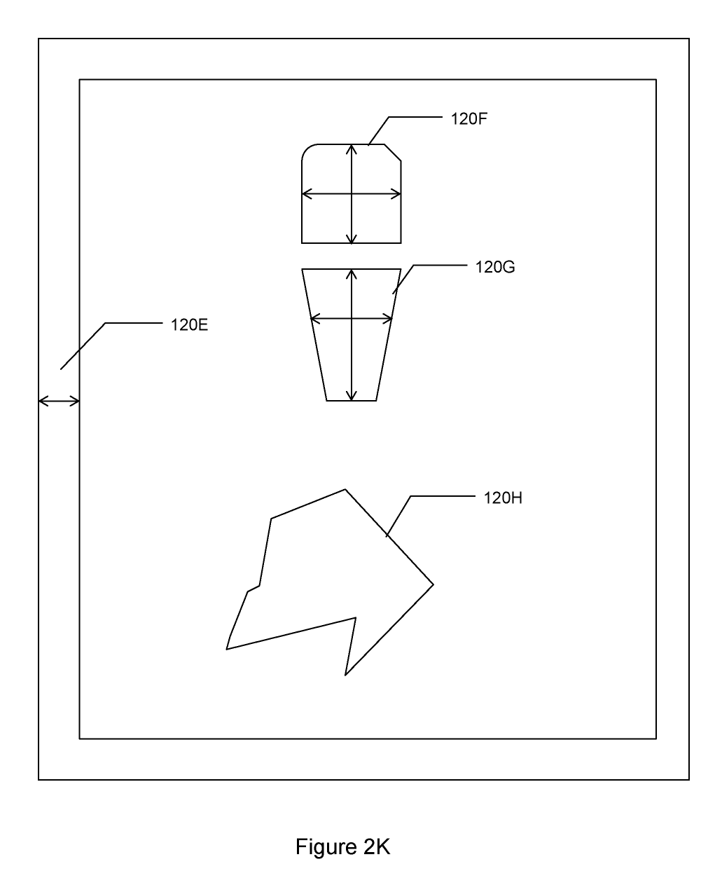

Refer to FIGS. 2A-2B. In the figures there are three sites with established geofences in the immediate vicinity of the user device 110 (Site A geofence 120, Site B geofence 130, Site C geofence 140).

As the user travels toward Site A, the user device 110 encounters the Site A geofence 120 the mobile application on the user device is triggered to access the mobile database and retrieve data and to provide information appropriate to Site A to the user via the user device 110.

Refer to FIGS. 2H-2J. In addition to geofences, the present invention also utilizes a user's line of sight to qualify or determine the appropriateness of which information or data to provide to the user.

Providing information to a user when the user cannot see the site, landmark, object, or scenery in not only essentially worthless but also can be frustrating for the user. To overcome this potentially negative aspect, the present invention determines whether or not the user can see the site from the user's current location or position.

In FIG. 2H both user device A 110A and user device B 110B have both crossed the standard Site A geofence 120B. However, Site A is situated in a location (for example the center of an intersection) that can only be seen from the streets or paths approaching Site A. Therefore, the Site A geofence 120A is established to trigger the mobile application on user device A 110A to access the mobile database and retrieve data and to provide information appropriate to Site A to the user via the user device 110A. Since the user of user device B cannot see Site A and they haven't crossed the line of sight site A geofence 120A, the mobile application of user device B 110B is not triggered and information is not provided to the user of user device B at their current location.

In FIG. 2I user device A 110A and user device B 110B are in front of Site A 120C and Site B 120D. Although the user of user device A 110A can see Site A 120C and the top of Site B 120D, the user of user device B 110B cannot see Site B 120D because it is blocked by Site A 120C.

The user of user device A is within the Site B geofence 120B and the Site A geofence 120A so the user of user device A 110A is provided with information about both Site A 120C and Site B 120D.

However, the user of user device B is within the Site A geofence 120A but is outside the Site B geofence 120B, the user of user device B 110B is provided with information about Site A 120C but is not provided with information about Site B 120D.

In FIG. 2J Site B is blocking Site A and the user of user device A 110 cannot see Site A. For example, Site B is a very tall office building and Site A is a 2 story historical building. The Site A geofence 120 is established so that the mobile application will not trigger until user device A turns the corner around Site B and the user of user of user device A 110 can see Site A. As a result, the Site A geofence 120 is established to trigger the mobile application on user device A 110 to access the mobile database and retrieve data and to provide information appropriate to Site A to the user via the user device 110A when the user of user device A 110 enters the line of sight of Site A.

In an embodiment the present invention utilizes viewshed analysis techniques to determine when and if the targeted object can be seen from the user's current location.

In an embodiment the present invention uses mapping and user location to determine when and if the targeted object can be seen.

Refer to FIGS. 2C-2D. In addition to geofences and line of sight, the present invention also utilizes the user's direction of movement to qualify or determine the appropriateness of which information or data to provide to the user.

In FIG. 2C the user device 110 has encountered the Site A geofence 120. However, the user of the user device 110 is traveling in the direction toward site B. Even though the user device 110 has contacted the Site A geofence 120 and is closer to Site A than Site B, the present invention determines and utilizes the direction of movement of the user of user device 110. Since the user of user device 110 is moving toward Site B and not Site A, the mobile application of the user device 110 is not triggered by the Site A geofence 120 and information appropriate for Site A is not provided to the user of user device B. However, when the user device encounters the Site B geofence 130, the mobile application on the user device 110 is triggered to access the mobile database and retrieve data and to provide information appropriate to Site B to the user via the user device 110.

In an embodiment of the present invention calculates the direction between two points based on latitude and longitude. To determine the direction from the starting point between two points the present invention uses the following formula:

Δφ=ln(tan(lat_{B}/2+π/4)/tan(lat_{A}/2+π/4))

Δlon=abs(lon_{A}−lon_{B})

bearing: θ=a tan 2(Δlon, Δφ)

Note: 1) ln=natural log 2) if Δlon>180° then Δlon=Δlon (mod 180).

Refer to FIG. 2E. In embodiments of the present invention different shapes of geofences are established according to different criteria such as usefulness, accuracy, and quality parameters and situations.

In FIG. 2E both rectangular shaped geofences 120, 130 and a circularly shaped geofence 140 are used to achieve the best results. Other shapes such as rhombus, pentagonal, triangular, irregular, amoebic, etc are also available to be used.

Refer to FIG. 2F. In embodiments of the present invention some geofences overlap.

In FIG. 2F a portion of the Site A geofence 120 overlaps a portion of the Site C geofence 140 and a portion of the Site B geofence 130 overlaps a portion of the Site C geofence 140. As a result, when the user of the user device 110 encounters and passes into a geofence as they move through the interior of the geofence area they will encounter another geofence while still within the original geofence.

For example, the user of the user device 110 passes through the Site A geofence 120 and the user device provides information appropriate for Site A. Then as the user moves toward Site C the user device 110 encounters the Site C geofence 140 while still within the Site A geofence 120 and the user device 110 provides information appropriate for Site C. As the user of the user device 110 continues toward Site C the Site A geofence 120 is encountered as the user leaves the Site A geofence 120 area.

However in this embodiment, since the Site A geofence 120 has already triggered the mobile application and the Site A information has already been provided to the user via the user device 110, the exiting of the Site A geofence 120 does not trigger the mobile application again and the user is not notified of the Site A information again. Similarly, if the user of the user device 110 returns toward Site A after visiting Site C and encounters the Site A geofence 120 again, the mobile application is not triggered to provide the information about Site A again.

In this embodiment a geofence only triggers the mobile application to provide the appropriate information to the user once.

In another embodiment of the present invention the entrance into a geofence triggers information appropriate for new visitors to the area, the exit out of the same geofence triggers information appropriate for visitors leaving the area, and re-entrance into the same geofence triggers information appropriate for return visitors. For example the information comprises a welcome, a thanks for visiting, an incentive to return to the area, a welcome and thanks for returning, or user visit history appropriate information.

In another embodiment the mobile application utilizes a timer to reset the trigger after a period of time. For example, the user visits Site A and is provided with the Site A information and then travels to Site C as the user exits the Site A geofence 120 the Site A information is not provided again. However, after the user spends a certain amount of time at Site C they decide they would like to return to Site A and learn more, when the user encounters the Site A geofence 120 again the mobile application is triggered and the Site A information is provided again since the timer had already reset the trigger.

Refer to FIG. 2G. In an embodiment of the present invention some geofences are in a nested configuration. In FIG. 2G the user of the user device 110 is provided with appropriate information in a layered fashion to affect the movement of the user.

For example, the implementation is an amusement park. Site A is a themed area of the park and as the user of the user device 110 encounters the overall Site A geofence 120 the user is provided with information about the entire themed area. Moving forward the user encounters the Site B geofence 130 for Site B which is a roller coaster ride and the user is provided with information about the roller coaster. However, on their way to the Site B roller coaster the user encounters the Site C geofence 140 for Site C which is a snack bar and the user is provide with information about discounts or products offered by the snack bar.

With the present invention the user is much more likely to visit the snack bar and make purchases than in a conventional situation without this directed and location based marketing.

Additionally other user behaviors can be controlled by layout and placement of geofences and the amount and type of information provided. For example, the movement, flow, direction of movement, and speed of movement of users can be controlled to benefit the users and implementers of the present invention.

In an embodiment of the present invention the mobile application maintains a record of the user's behavior. For example, the mobile application maintains a list of visited sites, the time spent at each visited site, number of photographs taken at the site, the amount of information the user interacted with, a list of the installed applications on the user device, etc. Periodically the mobile application sends the user's record to the application server or other server for reference, analysis, utilization, and customization.

In an embodiment of the present invention the graphical user interface of the mobile application allows the user to select and play or view the information in the mobile database at any time even when the user is not in the vicinity of the site.

Refer to FIG. 2K which illustrates various geofences. Geofence 120F and Geofence 120G are polygonal shaped geofences. Geofence 120H is a freeform irregularly shaped geofence. Geofence 120E surrounds Geofences 120F-120H but does not include Geofences 120F-120H. In other words, Geofences 120F-120H are located inside of Geofence 120E but are not nested in Geofence 120E. In this embodiment each geofence (Geofences 120E-120H) is separate and not nested in or overlapping any of the other geofences (Geofences 120E-120H).

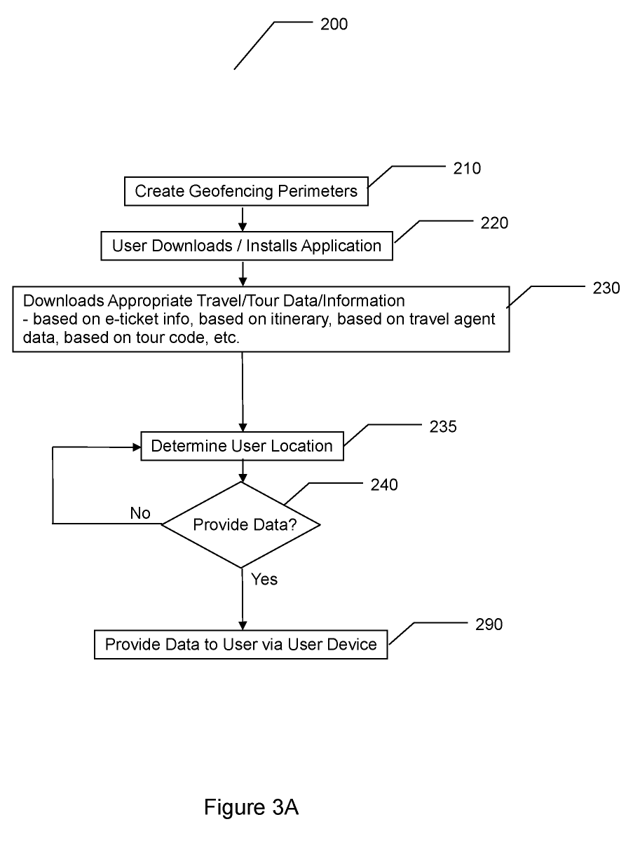

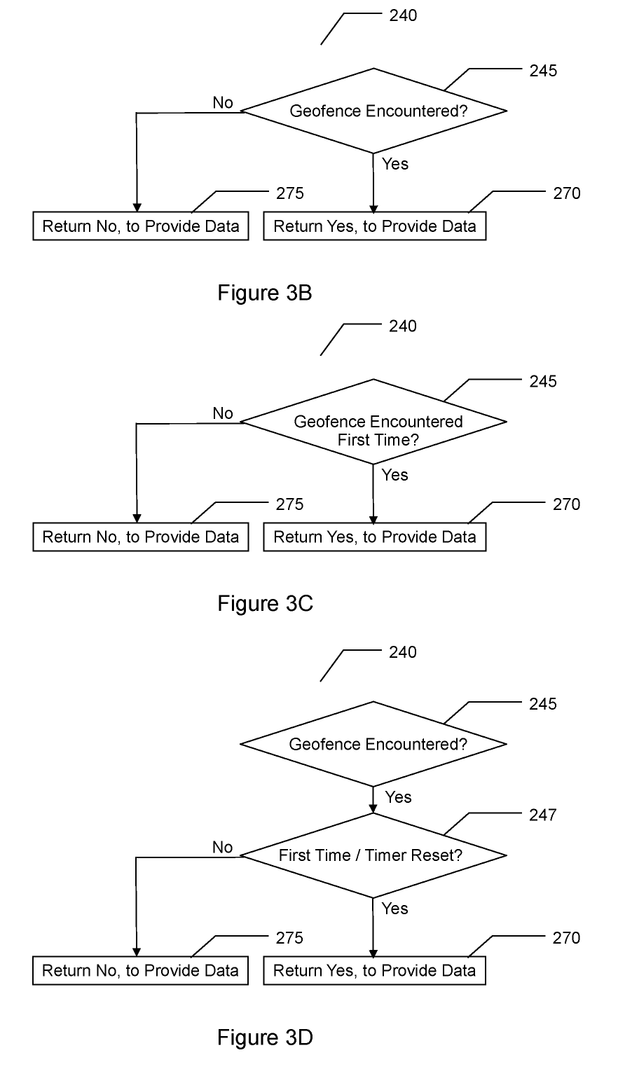

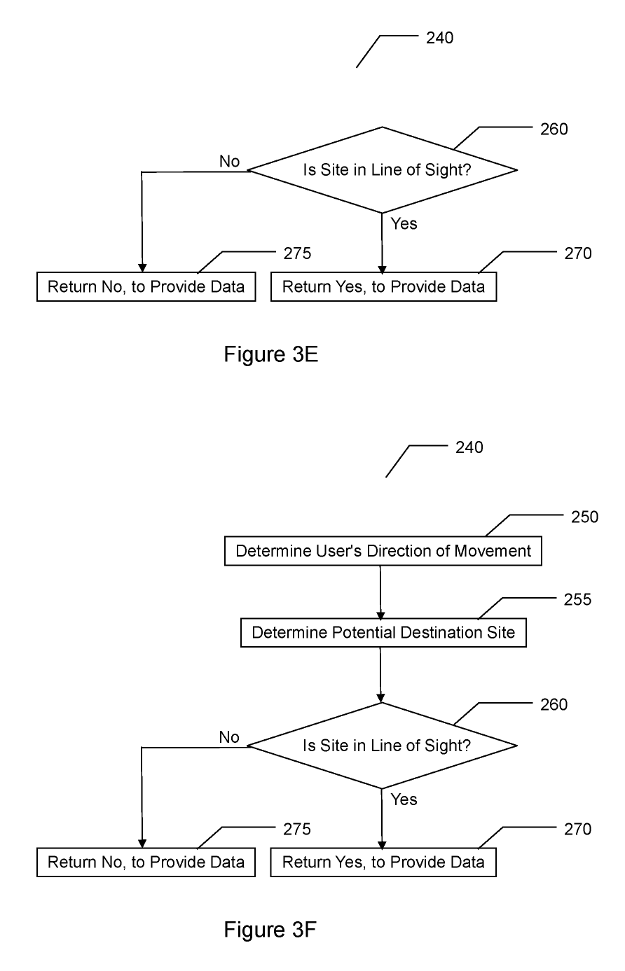

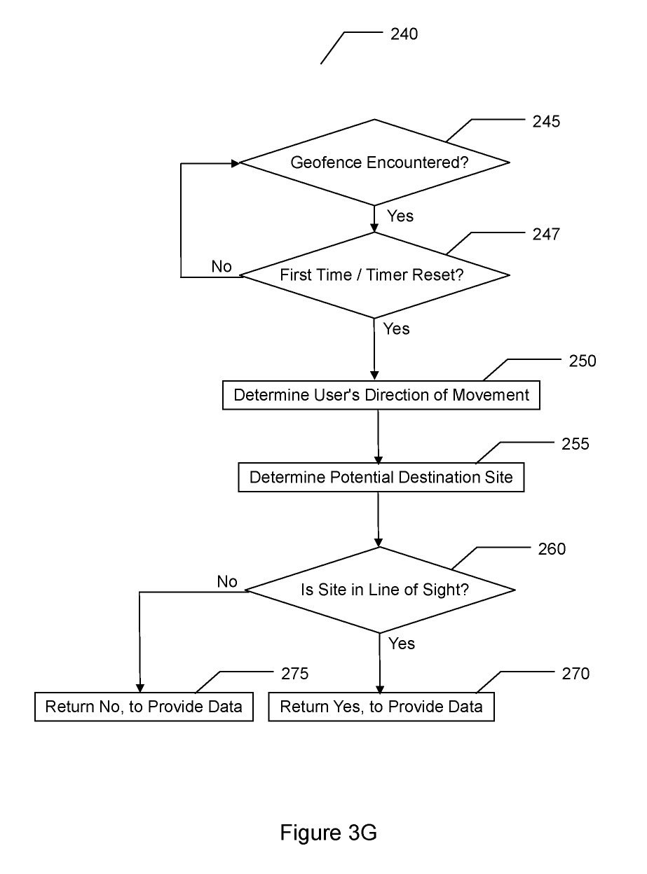

Refer to FIG. 3A, which is a flowchart illustrating a method 200 for providing appropriate information based on a user's location according to an embodiment of the present invention.

The method 200 starts by creating geofencing perimeters around sites in Step 210. In Step 220 a user downloads the mobile application and installs it on their user device. In Step 230 appropriate travel and tour data and information is download and stored in a mobile database of the mobile application. The appropriateness of the data is determined by, for example, information on an e-ticket, an airline ticket, travel itinerary, travel agent data, tour code, user selected request, flight code, flight number, country code, city code, etc.

In Step 235 the location of the user of the user device is determined. The present invention utilizes GPS, GPRS, 3G, 4G, Triangulation, or a combination of these to determine the location of the user device.

A decision on whether or not to provide data is made in Step 240. If no, then the data is not provided to the user and the method 200 returns to Step 235. If yes, then appropriate data is provided to the user via the user device in Step 290.

In FIGS. 3B-3D Step 240 of the method 200 comprises using a geofence to determine whether or not to provide data to the user.

Refer to FIG. 3B. In Step 245 a determination is made on whether or not the user device has encountered a geofence. If no, a no is returned on whether to provide data in Step 275. If yes, a yes is returned on whether to provide data in Step 270.

Refer to FIG. 3C. In Step 245 a determination is made on whether or not the user device has encountered a geofence for the first time. If no, a no is returned on whether to provide data in Step 275. If yes, a yes is returned on whether to provide data in Step 270.

Refer to FIG. 3D. In Step 245 a determination is made on whether or not the user device has encountered a geofence. If yes, a determination is made on whether or not the user device has encountered a geofence for the first time or whether or not the trigger timer has been reset in Step 247. If the user device has encountered the geofence previously, no data will be provided. If the user device has previously encountered the geofence and not enough time has passed for the trigger timer to reset, no data will be provided. If the user device has not encountered the geofence previously, data will be provided. If the user device has previously encountered the geofence and enough time has passed for the trigger timer to reset, data will be provided. In Step 247 if no, a no is returned on whether to provide data in Step 275. If yes, a yes is returned on whether to provide data in Step 270.

In FIG. 3E Step 240 of the method 200 comprises using line of site to determine whether or not to provide data to the user. In Step 260 a determination is made on whether or not a site is within the user's line of sight. In other words, can the user see the site from the user's current location? If no, a no is returned on whether to provide data in Step 275. If yes, a yes is returned on whether to provide data in Step 270.

In FIG. 3F Step 240 of the method 200 comprises using the user's direction of movement. In Step 250, the direction that the user is moving in is determined.

In Step 255, a potential destination site is determined using the user's direction of movement. In Step 260 a determination is made on whether or not the site is within the user's line of sight. In other words, can the user see the site from the user's current location? If no, a no is returned on whether to provide data in Step 275. If yes, a yes is returned on whether to provide data in Step 270.

Refer to FIG. 3G, which is a flowchart illustrating a method for providing appropriate information based on a user's location using geofences, line of sight, and direction of user movement.

In FIG. 3G the method 200 comprises in Step 245 a determination is made on whether or not the user device has encountered a geofence. If yes, a determination is made on whether or not the user device has encountered a geofence for the first time or whether or not the trigger timer has been reset in Step 247. If the user device has encountered the geofence previously or if the user device has previously encountered the geofence and not enough time has passed for the trigger timer to reset, return to Step 245. If the user device has not encountered the geofence previously or if the user device has previously encountered the geofence and enough time has passed for the trigger timer to reset, proceed to Step 250.

In Step 250, the direction that the user is moving in is determined. In Step 255, a potential destination site is determined using the user's direction of movement. In Step 260 a determination is made on whether or not the site is within the user's line of sight. In other words, can the user see the site from the user's current location? If no, a no is returned on whether to provide data in Step 275. If yes, a yes is returned on whether to provide data in Step 270.

It will be apparent to those skilled in the art that various modifications and variations can be made to the present invention without departing from the scope or spirit of the invention. In view of the foregoing, it is intended that the present invention cover modifications and variations of this invention provided they fall within the scope of the invention and its equivalent.

What is claimed is:

1. A platform and method for providing data based on a location of a user comprising:
determining the location of the user;
determining if the user has encountered a geofence;
determining if the data should be provided to the user;
providing the data to the user via a user device of the user if determined appropriate; and
not providing the data to the user via the user device of the user if determined not appropriate.

2. The platform and method for providing data based on a location of a user of claim 1, wherein GPS, GPRS, 3G, 4G, Triangulation, or a combination of GPS, GPRS, 3G, 4G, or Triangulation are utilized to determine the location of the user.

3. The platform and method for providing data based on a location of a user of claim 1, wherein a determination is made on whether or not the user device has encountered the geofence for a first time and if yes it is appropriate to provide the data to the user.

4. The platform and method for providing data based on a location of a user of claim 1, wherein a determination is made on whether the user device has encountered the geofence for a first time or whether a trigger timer has been reset and if yes it is appropriate to provide the data to the user.

5. The platform and method for providing data based on a location of a user of claim 1, wherein a determination is made on whether a site associated with the data is within a line of sight of the user and if yes it is appropriate to provide the data to the user.

6. The platform and method for providing data based on a location of a user of claim 1, wherein a direction of movement of the user is determined; a potential destination site is determined using the direction of movement; and a determination is made on whether the destination site is within a line of sight of the user and if yes it is appropriate to provide the data to the user.

7. The platform and method for providing data based on a location of a user of claim 6, wherein the direction of movement of the user is determined using formula:
Δφ=ln(tan(lat_{B}/2+π/4)/tan(lat_{A}/2+π/4));
Δlon=abs(lon_{A}−lon_{B});
bearing: θ=a tan 2(Δlon, Δφ);
wherein ln=natural log; and
wherein if Δlon>180° then Δlon=Δlon (mod 180).

8. The platform and method for providing data based on a location of a user of claim 5, wherein viewshed analysis is utilized to determine whether the site is within the line of sight of the user.

9. A platform and method for providing data based on a location of a user comprising:
creating a geofence and associating the geofence with a site;
determining the location of the user;
determining if the user has encountered the geofence;
determining if the site associated with the geofence is within a line of sight of the user; and
providing the data to the user via a user device of the user if determined appropriate; and
not providing the data to the user via the user device of the user if determined not appropriate.

10. The platform and method for providing data based on a location of a user of claim 9, wherein GPS, GPRS, 3G, 4G, Triangulation, or a combination of GPS, GPRS, 3G, 4G, or Triangulation are utilized to determine the location of the user.

11. The platform and method for providing data based on a location of a user of claim 9, wherein a determination is made on whether or not the user device has encountered the geofence for a first time and if yes it is appropriate to provide the data to the user.

12. The platform and method for providing data based on a location of a user of claim 9, wherein a determination is made on whether the user device has encountered the geofence for a first time or whether a trigger timer has been reset and if yes it is appropriate to provide the data to the user.

13. The platform and method for providing data based on a location of a user of claim 9, wherein a direction of movement of the user is determined; a potential destination site is determined using the direction of movement; and a determination is made on whether the destination site is within a line of sight of the user and if yes it is appropriate to provide the data to the user.

14. The platform and method for providing data based on a location of a user of claim 13, wherein the direction of movement of the user is determined using formula:
Δφ=ln(tan(lat_{B}/2+π/4)/tan(lat_{A}/2+π/4));
Δlon=abs(lon_{A}−lon_{B});
bearing: θ=a tan 2(Δlon, Δφ);
wherein ln=natural log; and
wherein if Δlon>180° then Δlon=Δlon (mod 180).

15. The platform and method for providing data based on a location of a user of claim 9, wherein viewshed analysis is utilized to determine whether the site is within the line of sight of the user.

16. A platform and method for providing data based on a location of a user comprising:
creating a geofence and associating the geofence with a site;
determining the location of the user;
determining if the user has encountered the geofence;
determining a direction of movement of the user;
determining if the site associated with the geofence is within a line of sight of the user; and
providing the data to the user via a user device of the user if determined appropriate; and
not providing the data to the user via the user device of the user if determined not appropriate.

17. The platform and method for providing data based on a location of a user of claim 16, wherein GPS, GPRS, 3G, 4G, Triangulation, or a combination of GPS, GPRS, 3G, 4G, or Triangulation are utilized to determine the location of the user.

18. The platform and method for providing data based on a location of a user of claim 16, wherein a determination is made on whether the user device has encountered the geofence for a first time or whether a trigger timer has been reset and if yes it is appropriate to provide the data to the user.

19. The platform and method for providing data based on a location of a user of claim 16, wherein the direction of movement of the user is determined using formula:
Δφ=ln(tan(lat_{B}/2+π/4)/tan(lat_{A}/2+π/4));
Δlon=abs(lon_{A}−lon_{B});
bearing: θ=a tan 2(Δlon, Δφ);
wherein ln=natural log; and
wherein if Δlon>180° then Δlon=Δlon (mod 180).

20. The platform and method for providing data based on a location of a user of claim 16, wherein viewshed analysis is utilized to determine whether the site is within the line of sight of the user.
